(19) United States
(12) Patent Application Publication
(10) Pub. No.: US 2010/0105804 A1
(43) Pub. Date: Apr. 29, 2010

(54) ONE-COMPONENT MOLD GROWTH-INHIBITING SANITARY JOINT SEALANT

(76) Inventors: Hans-Detlef Deike, Bad Laer (DE); Karl-Michael Müller, Halle/Westfalen (DE)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/516,818

(22) PCT Filed: Nov. 27, 2007
(86) PCT No.: PCT/EP2007/010276

§ 371 Date: Dec. 1, 2009

(30) Foreign Application Priority Data
Dec. 1, 2006 (DE) 10 2006 056 770.6

(51) Int. Cl. C09D 5/00

(52) U.S. Cl. 523/122

(57) ABSTRACT

The composition of a one-component, mould growth-inhibiting sanitary joint sealant is described, which sealant consists of 20 to 70% by mass of silane-terminated polyoxyalkylenes, 30 to 70% by mass of calcium carbonate powder, 0.1 to 5% by mass of organotin curing catalyst, mould growth-inhibiting additives based on 2-alkyl-2H-isothiazol-3-one in proportions by mass of 0.01 to 3% and optionally altogether 0 to 20% by mass of pigments, plasticizers, adhesion promoters, dispersants, other fillers and light and heat stabilizers.

The present invention describes the composition of one-component, mould growth-inhibiting sanitary joint sealants based on silane-terminated polyoxyalkylenes. Sanitary joints may be connection joints or expansion joints in the sanitary or wet area. Examples are the transitions from bath tubs, shower cabinets, wash basins or toilet facilities to tiled walls or floors. For aesthetic as well as hygienic reasons, virtually all these joints are packed in a permanently elastic manner with sanitary sealants.

In past years, very different materials were used as sealants for sanitary joints. However, polymeric substances were the basis for all these formulations. Ullmanns Encyclopedia der Technischen Chemie [Ullmann's Encyclopaedia of Industrial Chemistry], vol. A 23, 5th edition, 1993, page 499, makes a classification according to the raw material base as polysulphide sealants, polysiloxane sealants (referred to colloquially as silicones), polyacrylate sealants, polyurethane sealants, butyl rubber, PVC sealants and some very special types.

Some sealants, such as, for example, the polysulphide materials, are commercially available in two-component form. However, one-component silicone rubbers are predominantly used for sealing sanitary joints. After packing, the so-called RTV-1 silicone rubbers cure by means of atmospheric humidity with liberation of cleavage products to give elastic networks. Depending on the type of cleavage product, a distinction is made between basic systems (amine elimination), acidic systems (acetic acid elimination) and neutral systems (elimination of neutral compounds).

The known joint sealants, in particular the generally used one-component silicone systems, are, however, readily populated by moulds in the sanitary area. These moulds make use of degradation products of the sealants or organic impurities in the sealant formulations or residues from rinsing and washing processes (e.g. soap residues, shampoo, etc.) for their own metabolism. Consequently, unsightly and unhygienic, generally dark discolourations form on the joints. In addition, mould cultures in the human living environment constitute a health risk which should not be underestimated, owing to the spores released by them into the room air.

In order to prevent mould formation on the sanitary joints, small amounts of biocides are usually added to the joint sealing compounds, as a rule silicone sealing compounds. The extremely extensive patent literature belonging to the prior art recommends very different substances and classes of substances. In his book “Biozide in Bautenbeschichtungen, expert Verlag, 2000, Renningen” [Biocides in the coating of structures, expert Verlag, 2000, Renningen], E. Bagda gives a comprehensive overview of the active substances and classes of active substances used. According to this, the following classes of compounds are suitable in practice: triazoles, iodine compounds, dithiocarbamates, pyridine derivatives, benzothiazole derivatives, isothiazolinones, organochlorine compounds having various structures, triazines and certain urea derivatives.

For the practical use of these mould-destroying or mould growth-inhibiting compounds, a high activity against moulds is required but no harm should occur to humans. In addition, the active substance must be chemically compatible with the other components of the sealant formulations, in order to avoid losing efficiency during storage up to sale and in order to avoid adversely affecting the storage stability of the formulated joint sealants. The active substances in question are also not permitted to have an adverse effect on the joint adhesion and the curing behaviour of the sanitary sealants. Finally, another requirement is that the active substances do not adversely affect the colour of the sealants. This point is particularly important in the case of transparent or pale-coloured formulations. However, the greatest problem is the rapid loss of activity of the currently used compounds which is observed in practice. The main cause of this is washing of the active substances out of the sanitary joints. As a result, mould populations subsequently rapidly form again on the joint surfaces.

It was therefore an object of the present invention to provide sanitary joint sealants which are not attacked or at least not significantly attacked by moulds in the long term but continue to have the advantageous adhesion and expansion values of the polyorganosiloxanes usually used.

It was found that sanitary joint sealants based on silane-terminated polyoxyalkylenes are only slightly populated by moulds even after relatively long contact with water. A reason for this could be the long polyoxyalkylene chains or preferably polyoxypropylene chains in the silane-terminated prepolymers, since such constitutions are avoided by moulds. Overall, these sanitary joint sealants are markedly less susceptible to mould attack than the silicone sealants commercially available today.

Hybrid polymers comprising customary backbone polymers, such as, for example, polypropylene oxide, were developed more than 25 years ago. The silane groups predominantly carry methoxy groups, from which methanol is liberated by atmospheric humidity during the curing process. The resulting silanol groups then react further with crosslinking to give an elastic and insoluble polymeric network. This reaction can be accelerated by the addition of so-called curing catalysts, in practice condensation catalysts.

These hybrid polymers, more precisely prepolymers are marketed by the industry under the name MS polymer (silane-modified polyoxyalkylenes). In the book “Kleben, Springer Verlag, 3. Auflage, Berlin, 1997” [Adhesive bonding, Springer Verlag, 3rd edition, Berlin, 1997], G. Habenicht gives an overview of this technology. A further description can therefore be dispensed with here.

An advantageous development of the invention is given in Patent Claim 3. According to this, a mixture of two methoxyalkylsilane-terminated polyoxypropylenes having viscosities of 5 to 10 Pa·s and 10 to 25 Pa·s, respectively (measured at 20° C. and a shear gradient of 1 s⁻¹) in a mass ratio of 5:1 to 1:5 is used. The alkyl groups may contain 1 to 10 C atoms. By this combination of the two prepolymer types, the flow behaviour of the claimed coating materials can be optimally adjusted between low-viscosity and viscous.

The viscosity of the silane-modified polyoxypropylene prepolymer is determined by the molar masses or the molar mass distribution of MS polyoxypropylenes. In practice, the number average molar mass of the silane-terminated polyoxypropylene prepolymers used, i.e. prior to hydrolytic elimination of the methoxy groups, should be between about 1000 and about 30 000 g/mol.

According to Claim 1, the one-component, mould growth-inhibiting sanitary joint sealants contain 30 to 70% by mass of hydrophobized and/or untreated calcium carbonate powder. The calcium carbonate materials used are hydrophobized with customary stearin compounds, such as, for example, calcium stearate or stearic acid. The stearate content should not exceed 3%.

In general, the calcium carbonate addition has the function of adjusting the physical and mechanical properties of the claimed sealing materials as far as possible to correspond to the application. In particular, the stabilities are advantageously influenced by the calcium carbonate addition. At the same time, the viscosity can be increased to the desired level.

The particle size of the calcium carbonate powders used may vary within a wide range depending on the layer thicknesses strived for. For the purposes of the present invention, however, calcium carbonate powders having particle sizes of less than 20 μm and particularly preferably less than 10 μm are preferably used.

In order to accelerate the curing of the sealants according to the invention after application, silanol condensation catalysts (curing catalysts) are added in the preparation. In particular, carboxylates and chelates of tin have proved to be suitable. Dibutyltin diacetylacetonate is particularly suitable. The proportion by mass of the catalyst is 0.1 to 5% by mass, preferably 0.1 to 1% by mass.

Since the methoxy groups of the silane-terminated prepolymers hydrolyse and crosslink under the action of moisture and in the presence of a curing catalyst, it is necessary to add a drying agent having the function of a water scavenger to the claimed sanitary joint sealants during the preparation. As a result, the storability of the adhesives and sealants can be ensured. A particularly suitable drying agent is vinyltrimethoxysilane. Owing to the electronic structure of this compound, the methoxy groups of the drying agent hydrolyse very much more rapidly than the methoxy groups of the MS polymers used. Only when the drying agent has been substantially consumed does crosslinking of the MS polymers take place. The added amounts of vinyltrimethoxysilane are based on the water content of the starting materials; in practice, they are generally in the range of 1-3% by mass.

For improving the adhesive properties of the joint sealants on surfaces, adhesion promoters, especially those based on silanes, may also be added. Additions of 0.2 to 5% by mass of aminofunctional alkoxysilanes, such as, for example, aminopropyltriethoxysilane or aminopropyltrimethoxysilane, have proved to be expedient.

In addition, the sanitary joint sealants according to the invention may contain customary additives, such as, in particular coloured pigments, plasticizers, light and heat stabilizers, dispersants and fillers in an amount of, altogether, 0 to 20% by mass. Coloured pigments, for example titanium dioxide, iron oxide, carbon black or organic colorants, are suitable for colouring the formulations.

As plasticizers, it is possible to resort to tried and tested compounds. The known phthalic esters, cyclohexanedicarboxylic esters or polypropylene oxide may primarily be mentioned here.

Other possible additives, which may be useful from case to case, are finely divided fillers, coated or uncoated. The following may be mentioned as examples: dolomite, talc, mica and barite and the pyrogenic silica having a reinforcing effect.

According to an additional feature of the present invention, certain fungicides can be incorporated into the sanitary joint sealants according to the invention for enhancing the activity. Practical experiments have shown that the 2-alkyl-2H-isothiazol-3-ones having alkyl groups of 1 to 10 carbon atoms are particularly suitable for this purpose. 2-Octyl-2H-isothiazol-3-one or 4,5-dichloro-2-octyl-2H-isothiazol-3-one in proportions by mass of 0.01 to 1.0% is preferably used. Owing to its lower water solubility and the resulting longer period of action, the latter is preferred here. The addition can be effected in pure form or, in a simpler operation, in solution in organic carrier substances, such as, for example, high-boiling esters or hydrocarbons.

For testing the mould growth-inhibiting action of the sanitary joint sealants according to the invention, sealant sheets measuring about 50 mm×30 mm×2 mm are produced from the claimed formulations by spreading out and are allowed to cure at room temperature and 60% relative humidity. The inhibitory effect is assessed on the basis of the standard DIN EN ISO 846: “Bestimmung der Einwirkung von Mikroorganismen auf Kunststoffe” [Determination of the effect of microorganisms on plastics]—method A.

For this purpose, the test sheets or round cut-outs were placed on the surface of incomplete agar in sterile Petri dishes and carefully inoculated with a mould suspension defined in DIN EN ISO 846. After incubation, the mould broth was assessed visually. The incubation conditions were standardized at 29° C. and >95% relative humidity and a duration of incubation of 4 weeks.

The mould growth on the test sheets was assessed according to the following classes. For high-quality sanitary joint sealants, only assessment classes 0 and 1 are suitable.
0: no growth detectable when viewed under the microscope
1: no growth detectable with the naked eye but clearly detectable under the microscope
2: growth detectable with the naked eye, up to 25% of the sample surface covered with growth
3: growth detectable with the naked eye, up to 50% of the sample surface covered with growth
4: growth detectable with the naked eyed, over 50% of the sample surface covered with growth
5: strong growth, entire sample surface covered with growth

The sanitary joint sealants according to the invention are injected from cartridge guns (commercial users) or dispensers (DIY workers) into the joints. The joint sealants adhere to all building materials customary in the sanitary sector, such as, for example, metals, plastics, natural stones, ceramic, porcelain or glass. Application is possible to perpendicular or horizontal joints. Priming is as a rule not necessary. After application of the joint sealants, the joint sealing compound vulcanizes by means of atmospheric humidity in the course of 24 to 48 hours to give a resiliant and flexible material. The shrinkage is very low at 2 to 3% by volume, the tensile stress at 100% elongation is about 0.3 N/mm² (20° C.), the elastic recovery is over 70% (according to DIN EN 27389) and the maximum absorption of movement is about 25%. In addition, the packings remain permanently elastic, i.e. do not harden, and are also light-stable. The sanitary joint sealants according to the invention are prepared in vacuum mixers operated batchwise. For the preparation, the liquid silane-terminated polymer components (MS polymers) are initially introduced into the mixer. Then, if required, plasticizers, pigments and light stabilizers are added.

At this time, it is also possible, if desired, to add 2-alkyl-2H-isothiazol-3-ones. These starting materials are carefully mixed and then the solid components, mainly calcium carbonate powder, are incorporated with strong shearing and a simultaneous application of a slight vacuum (about 100 mbar).

After cooling of the batch to 50° C. or below, the drying agent is added. Thereafter, adhesion promoters and curing catalysts are added and mixed in. Since gas bubbles may have formed again in the batch as a result of the mixing process, degassing is finally effected briefly once again.

### EXAMPLES

### Example 1

Sanitary joint sealing compound was prepared according to the following formulation:

10 kg of polyoxypropylene, dimethoxymethylsilane-terminated, 8 Pa·s
15 kg of polyoxypropylene, dimethoxymethylsilane-terminated, 12 Pa·s
2.0 kg of titanium dioxide pigment
10 kg of diisononyl phthalate
0.20 kg of bis(2,2,6,6-tetramethyl-4-piperidyl)sebacate
45 kg of hydrophobized calcium carbonate powder (90% by mass<10 μm)
1.1 kg of vinyltrimethoxysilane
0.6 kg of aminopropyltrimethoxysilane
0.35 kg of dibutyltin diacetylacetonate

For the test, the coating material obtained was spread out on Teflon substrates to give 2 mm thick sheets and left to cure for 1 week at 25° C. and 60% relative humidity. The characteristic values obtained from the tests are listed in Table 1.

### Example 2

Sanitary joint sealing compound was prepared according to the following formulation:

10 kg of polyoxypropylene, dimethoxymethylsilane-terminated, 8 Pa·s
15 kg of polyoxypropylene, dimethoxymethylsilane-terminated, 12 Pa·s
10 kg of diisononyl phthalate
2.0 kg of titanium dioxide pigment
0.20 kg of bis(2,2,6,6-tetramethyl-4-piperidyl)sebacate
45 kg of hydrophobized calcium carbonate powder (90% by mass<10 μm)
1.1 kg of vinyltrimethoxysilane
0.6 kg of aminopropyltrimethoxysilane
0.5 kg of 2-octyl-2H-isothiazol-3-one (5% strength preparation)
0.35 kg of dibutyltin diacetylacetonate

For the test, the material was spread out on an aluminium plate in a layer thickness of 2 mm and left to cure for 1 week at 25° C. and 60% relative humidity. The characteristic values were then determined (Table 1).

### Example 3

Sanitary joint sealing compound was prepared according to the following formulation:

10 kg of polyoxypropylene, dimethoxymethylsilane-terminated, 8 Pa·s
15 kg of polyoxypropylene, dimethoxymethylsilane-terminated, 12 Pa·s
10 kg of diisononyl phthalate
2.0 kg of titanium dioxide pigment
0.2 kg of bis(2,2,6,6-tetramethyl-4-piperidyl)sebacate
45 kg of hydrophobized calcium carbonate powder (90% by mass<10 μm)
1.1 kg of vinyltrimethoxysilane
0.6 kg of aminopropyltrimethoxysilane
0.25 kg of 4,5-dichloro-2-octyl-2H-isothiazol-3-one (10% strength preparation)
0.35 kg of dibutyltin diacetylacetonate

For the test, the material was spread out on aluminium plates or adhesive polyethylene film in a layer thickness of 2 mm and left to cure for 2 weeks at 23° C. and 60% relative humidity. The characteristic values were then determined (Table 1). The two reference silicones were acetate-crosslinking types, silicone 1 without mould growth-inhibiting additives and silicone 2 with mould growth-inhibiting additives.

| Characteristic value | Example 1 | Example 2 | Example 3 | Silicone 1 | Silicone 2 |
|---|---|---|---|---|---|
| Density (kg/l) | 1.5 | 1.5 | 1.5 | 1 | 1 |
| Skin formation (min) | 60 | 60 | 60 | 12 | 15 |
| (23° C./60% relative humidity) | | | | | |
| Curing (mm/24 h) | 2.5 | 2.5 | 2.5 | 3.5 | 3 |
| (23° C./60% relative humidity) | | | | | |
| Tensile stress at 100% | 0.36 | 0.38 | 0.39 | 0.16 | 0.23 |
| elongation (N/mm²) | | | | | |
| SHORE A hardness | 28 | 30 | 27 | 15 | 19 |
| Mould growth class according | 1 | 0 | 0 | 3 | 1 |
| to DIN EN ISO 846 | | | | | |

1. One-component, mould growth-inhibiting sanitary joint sealant, characterized in that it consists of 20 to 70% by mass of silane-terminated polyoxyalkylenes, 30 to 70% by mass of calcium carbonate powder, 0.1 to 5% by mass of organotin curing catalyst, 0.01 to 3% by mass of mould growth-inhibiting biocides and optionally altogether 0 to 20% by mass of coloured pigments, plasticizers, adhesion promoters, dispersants, other fillers and light and heat stabilizers.

2. One-component, mould growth-inhibiting sanitary joint sealant according to claim 1, characterized in that it contains one or more methoxyalkylsilane-terminated polyoxypropylene types having alkyl groups of up to 10 carbon atoms and having a viscosity of 0.5 to 25 Pa·s (measured at 20° C. and a shear gradient of 1 s⁻¹) as the silane-terminated polyoxyalkylenes.

3. One-component, mould growth-inhibiting sanitary joint sealant according to claim 1, characterized in that it contains two methoxyalkylsilane-terminated polyoxypropylene types having alkyl groups of up to 10 carbon atoms and having a viscosity of 5 to 10 Pa·s and 10 to 25 Pa·s, respectively (measured at 20° C. and a shear gradient of 1 s⁻¹) in the mass ratio of 5:1 to 1:5 as the silane-terminated polyoxyalkylenes.

4. One-component, mould growth-inhibiting sanitary joint sealant according to claims 1 and 2, characterized in that it additionally contains 0.01 to 1.0% by mass of 2-alkyl-2H-isothiazol-3-ones having alkyl groups of 1 to 10 C atoms, preferably in the form of a suitable preparation.

5. One-component, mould growth-inhibiting sanitary joint sealant according to claims 1 to 4, characterized in that it contains 0.01 to 1.0% by mass of 2-Octyl-2H-isothiazol-3-one, preferably in the form of a suitable preparation.

6. One-component, mould growth-inhibiting sanitary joint sealant according to claims 1 to 4, characterized in that it contains 0.01 to 1.0% by mass of 4,5-dichloro-2-octyl-2H-isothiazol-3-one, preferably in the form of a suitable preparation.
